(19) United States
(12) Patent Application Publication
(10) Pub. No.: US 2019/0059395 A1
(43) Pub. Date: Feb. 28, 2019

(54) PLATEN APPARATUS AND METHOD TO COOK DOUGH PRODUCTS USING A COMBINATION OF CONVECTION AND CONDUCTION METHOD OF HEATING

(71) Applicant: SECTORQUBE TECHNOLABS PRIVATE LIMITED, Kerala (IN)

(72) Inventors: Nibu Alias, Kerala (IN); Ani Abraham Joy, Kerala (IN); Midhun Skaria, Kerala (IN)

(21) Appl. No.: 16/118,868

(22) Filed: Aug. 31, 2018

(30) Foreign Application Priority Data
Aug. 31, 2017 (IN) 201741030910

(51) Int. Cl. A21C 11/00; A21D 13/43; A21D 8/06

(52) U.S. Cl. CPC A21C 11/006; A21D 8/06; A21D 13/43

(57) ABSTRACT

The present invention discloses a platen apparatus (300) and method (400) for cooking dough using a combination of convective and conductive heating. The apparatus (300) comprises a platen unit including a top heating assembly (320) and a bottom heating assembly (310) to press a dough ball into a flat disc, the bottom heating assembly (310) including a first heating unit configured to provide conductive heat to the platen unit; a linear motion mechanism (350) configured to move the top heating assembly (320) linearly with respect to the bottom heating assembly (310); and a second heating unit (314) including a secondary heating coil (332) and a blower unit (331) to provide convective heat to the platen unit; and a control unit to control the heating of the platen unit; such that the temperature of the second heating unit (314) is higher than the temperature of the first heating unit.

### FIELD OF THE INVENTION

This invention generally relates to an apparatus, system and a method for cooking dough products. More particularly, the invention relates to the apparatus and a method for cooking dough products using a combination of convection and conduction method of heating.

### BACKGROUND OF INVENTION

In India, flatbreads or disc-shaped breads are one of the most common food items consumed by the people. These flatbreads include chapattis, rotis, paranthas, puris and the like. Other forms of flatbreads or disc shaped breads such as pizza and tortillas are also made in other parts of the world. Conventionally, such flatbreads or disc-shaped breads were made from dough manually in households. However, with the advent of technology, several food processing devices and systems for kneading the dough and making flatbreads from the kneaded dough were introduced to reduce the manual effort and time taken for making the flatbreads.

However, in order to cook the flatbreads, it is necessary that the flatbreads are flipped at the correct time and cooked at the correct temperature so that they are soft and puffy. The present food processing devices and systems are equipped to knead the dough, prepare dough balls, press the dough balls into flatbreads or disc shaped breads and cook them utilising a pressing unit and a single heating unit. However, the flatbreads obtained from such single pressing platens are of low quality, since it is very difficult to identify the exact temperature at which the flatbread has to be cooked and flipped. Even if, it is done manually, the temperature profile maintained in such devices cause the flatbreads to lose its moisture and become chewy, if not used within few minutes after cooking it. These systems were then modified to include multiple pressing units, generally two, comprising separate heating units, which could heat and cook the flatbread from both the sides i.e. top and bottom, so that there is no need of flipping the bread. However, even then, the flatbread obtained becomes dry and loses its softness, after taken out of the processor and also, such systems comprising multiple pressing and heating units are bulky, occupy more space and more energy to operate.

Thus, there is a need of an apparatus, system and a method which can overcome the above drawbacks of existing food processing systems for kneading and cooking dough products into flatbreads or disc-shaped breads.

### OBJECT OF INVENTION

In view of the foregoing, the object of the invention is to provide a platen apparatus for cooking dough products more effectively and efficiently.

It is another object of the invention to provide a platen apparatus for conventional and conductive heating for cooking dough products.

It is yet another object of the invention to provide a method for conventional and conductive heating of dough products.

### SUMMARY OF THE INVENTION

In one aspect, the invention discloses a platen apparatus for cooking dough products comprising a platen unit including a top heating assembly and a bottom heating assembly to press a dough ball into a flat disc, the bottom heating assembly including a first heating unit that includes at least one primary coil configured to provide conductive heat to the platen unit, a linear motion mechanism configured to move the top heating assembly linearly with respect to the bottom heating assembly; a second heating unit including a secondary heating coil and a blower unit configured to provide convective heat to the platen unit, and a control unit configured to control the heating of the platen unit, wherein heat from the secondary heating coil of the second heating unit is circulated by the blower unit within the platen unit, and wherein the temperature of the second heating unit is higher than the temperature of the first heating unit. In another aspect of the invention, the blower unit of the second heating unit is a fan to circulate the heat from the secondary heating coil. In yet another aspect of the invention, top heating assembly and bottom heating assembly are coated with a non-sticky material such as Teflon.

The first heating unit according to the present invention is responsible for the conductive heating of the platen unit. In one aspect, the initial conductive pre-heating of the plates for cooking the flat disc is done by the first heating unit. The second heating unit according to the present invention is responsible for the convective heating of the platen unit.

In another aspect of the invention, the first heating unit and the second heating unit are connected to a power supply for heating the platen unit.

In another aspect of the invention, the linear motion mechanism of the platen apparatus is mounted on the top heating assembly of the platen unit.

In yet another aspect of the invention, the linear motion mechanism includes a plurality of shafts, a lead screw connected to the plurality of shafts by a shaft holder, the lead screw along with the plurality of shafts actuating linear motion of the top heating assembly through a guide system which is connected to the top heating assembly by an insulating plate.

In yet another aspect of the invention, the platen unit includes at least one temperature sensor attached to the top and bottom assemblies to detect and monitor the temperature of heater plates of the assemblies.

In another aspect of the invention, the platen unit comprises at least one contact sensor to detect the position of the top heating assembly.

In another aspect of the invention, the first heating unit of the bottom heating assembly comprises at least one Teflon coated heater plate to enable conductive heating.

In yet another aspect of the invention, the platen unit includes a plurality of sensors to detect whether the flatbread is cooked.

In another embodiment, the sensors for detecting the position of the plate and to detect whether the flatbread is cooked or not may be rotary encoders, contact sensors, hall sensors, infrared sensors, ultrasonic sensors etc.

In yet another aspect of the invention, when the platen unit detects that the flatbread is cooked, the control unit control unit cuts off the power supplied to the platen unit.

In yet another aspect of the invention, the blower unit is a fan to circulate air through a specified path around the secondary heating coil and the apparatus to provide convection heat in between the bottom heating assembly and top heating assembly in a region where the flatbread is placed for cooking. In an embodiment, the specified path comprises a radiation heating system to improve cooking quality.

In yet another aspect of the invention, the top heating assembly, the bottom heating assembly and the specified path act as an enclosure to hold the heat for cooking the flatbread.

In still another aspect, the invention discloses a method for cooking the dough products. In one embodiment, the first step of the method is flattening of the dough ball into a flatbread using the platen unit that includes the top heating assembly and the bottom heating assembly followed by providing conduction heat to the flatbread using the first heating unit of the bottom heating assembly and providing convectional heat using a second heating unit such that the temperature of the second heating unit providing convectional heat is greater than the temperature of the first heating unit providing the conductional heat to the platen unit.

In still another aspect of the invention, conductive heat is provided by the first heating unit simultaneously with the convectional heat provided by the second heating unit. In one aspect of the invention, the flatbread is cooked by the linear motion of the top heating assembly of the first heating unit and the combination of conduction heat provided by the first heating unit and convection heat provided by the second unit. The linear motion of the top heating assembly is caused by a linear motion mechanism which includes a plurality of shafts, a lead screw connected to the plurality of shafts by a shaft holder, the lead screw along with the plurality of shafts actuating linear motion of the top heating assembly through a guide system which is connected to the top heating assembly by an insulating plate. In another embodiment, the conductive heat to the platen unit to cook the flatbread is provided by the first heating unit using a primary coil which heats up when power is supplied to it. The convective heat is provided by the second heating unit by a secondary heating coil including at least one heating coil and a blower unit. In one aspect the blower unit is a fan. The amount of heat to be supplied by the first heating unit and the second hearting unit is controlled by a control unit through a plurality of sensors, which detect the position of the top plate, temperature of the platen unit and whether the flatbread is cooked or not.

In yet another embodiment of the invention, the amount of heat supplied by the first heating unit and the second hearting unit is controlled by a control unit.

### BRIEF DESCRIPTION OF THE DRAWINGS

The accompanying drawings constitute a part of the description and are used to provide further understanding of the present invention. Such accompanying drawings illustrate the embodiments of the present invention which are used to describe the principles of the present invention together with the description.

FIG. 1 illustrates a platen apparatus according to an embodiment of the present invention.

FIG. 2 illustrates the linear motion mechanism according to the embodiment of the present invention.

FIG. 3 illustrates the interior of a heater plate used in the platen apparatus in an embodiment of the present invention.

FIG. 4 illustrates a second heating system for convective heating according to an embodiment of the present invention.

FIG. 5 illustrates the various steps involved in the method for cooking dough products according to an embodiment of the present invention.

### DETAILED DESCRIPTION OF THE INVENTION

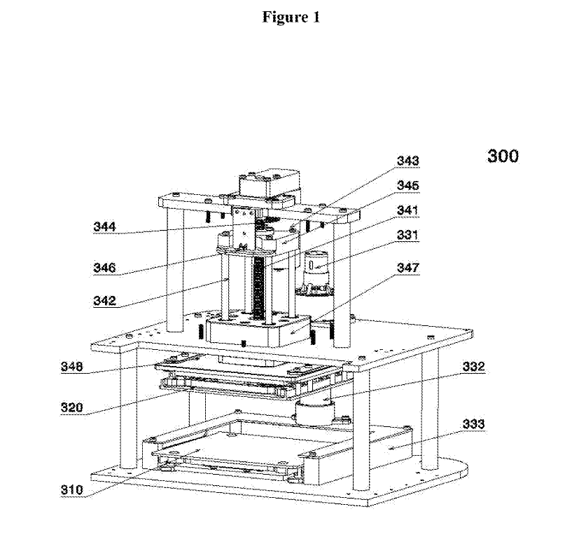

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. FIG. 1 illustrates a platen apparatus for cooking flatbreads made from dough balls, using conductive and convectional heating methods. In an embodiment, the platen apparatus comprises of a platen unit comprising a top heating assembly (interchangeably referred to as “top plate” hereinafter) (320) and a bottom heating assembly (interchangeably referred to as “bottom plate” hereinafter) (310) wherein the bottom heating assembly (310) is stationary and the top heating assembly (320) moves linearly with respect to the bottom heating assembly (310) to press the dough ball into a flatbread or a disc-shaped bread. The top side of each plate is coated with Teflon to make it non-sticky. The linear motion of the top plate (320) is performed by a linear motion mechanism (350). The platen apparatus contains a first heating unit that provides conductive heat to the respective plates (310, 320). The first heating unit includes a primary heating coil (311) associated with at least one heating assembly (310, 320). In an embodiment, the bottom heating assembly (310) includes the first heating unit for conductive heating of the flatbread placed on the bottom heating assembly (310).

The platen apparatus further comprises of a secondary heating coil (314) attached to the base using the specified path (333), including a secondary heating coil (332) and a blower unit (331) to provide convective heat to the platen unit. The blower unit (331) may be a fan or a blower to circulate the heated air in between bottom heating assembly (310) and top heating assembly (320). The convective heat is maintained at a relatively higher temperature than that of the conductive heat. While the higher convective heat from the second heating unit (314) is used for the faster cooking and puffing of the flat bread, the lower which prevents the dough to stick on to the heater plate while pressing by the top heating assembly. The conductive heat from the first heating unit also reduces the required force to press the dough ball into a disc.

In another embodiment of the invention, separate temperature sensor units (312) attached to both the heating assemblies (310, 320) in order to continuously monitor and regulate its temperature. These sensors cut off the power supplied to the top and bottom heating assemblies (310, 320) as soon as the required temperature level has reached on each assemblies (310, 320) and thus maintains a temperature profile of the top and bottom heating assemblies (310, 320).

In another embodiment of the invention, different sensors are placed around the platen unit to identify whether the flatbreads are cooked, and once it has been identified that the flatbreads are cooked, the control unit cuts off the power supply to the primary and secondary heating coils and stop the heating of the platen unit. Thus, the conductive and convective heating of the platen unit using first heating unit and second heating unit, is controlled by the control unit.

In another embodiment of the invention, contact sensors are placed in the platen unit, which are used to detect the position of the top heating assembly (320). The sensors are configured to detect if the top heating assembly (320) has reached its upper threshold point. The sensors also detect the maximum pressing level at the bottom. These sensors are used to avert such motion of the top heating assembly (320) which could cause damage to the entire system and to itself as well. In yet another embodiment, the pressing level and the position of the top plate can be adjusted by the user. In another embodiment, a plurality of sensor may be used for detecting the position of the top plate. In another embodiment, the sensors for detecting the position of the plate may be rotary encoders, contact sensors, hall sensors, infrared sensors ultrasonic sensors etc.

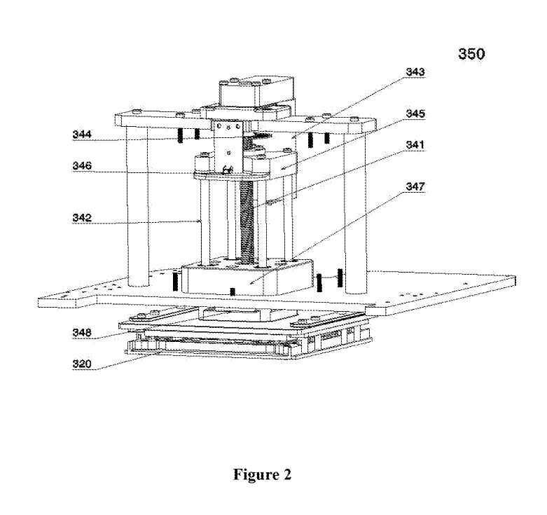

FIG. 2 illustrates the linear motion mechanism (350) of the platen apparatus. The linear motion of the top heating assembly (320) is achieved by a lead screw (341). The lead screw (341) is run by a plurality of motors (343). The mechanism (350) has a plurality of shafts (342) that are mounted to the top heating assembly (320). The plurality of shafts (342) are connected to the lead screw by shaft holder (345). The lead screw (341) along with the plurality of shafts (342) actuates the linear motion through the guide system (347) which is connected to the top heating assembly (320) by insulating plate (348).

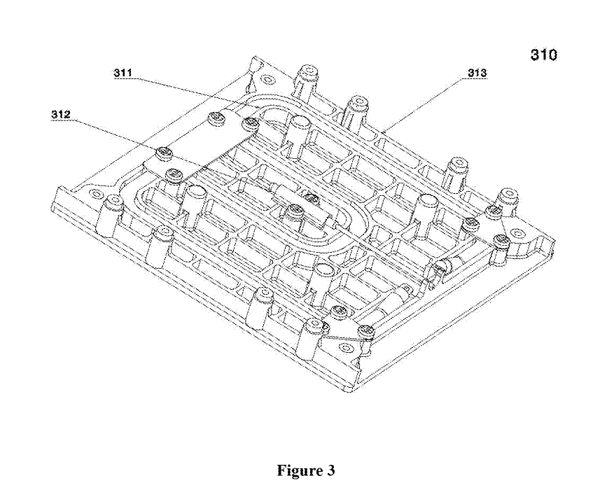

FIG. 3 illustrates the bottom heating assembly (310) that includes the first heating unit including a Teflon coated heater plate (313) that is responsible for the conductive heat in the apparatus. In an embodiment, the first heating unit comprises a primary heating coil (311). The primary coil (311) is powered by an AC supply, by which the bottom plate (310) to which it is connected is heated. A temperature sensor (312) is provided on the plate to monitor and control the temperature of the heater plate (313). In another embodiment, the first heating unit may be configured with the top heating assembly (320).

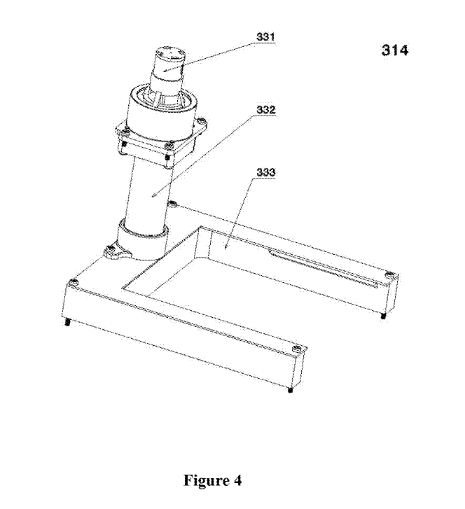

FIG. 4 illustrates the second heating unit (314) that is used to provide convective heat in the apparatus. This second heating unit (314) contains a secondary heating coil (332) and a blower unit (331). The secondary heating coil (332) includes at least one heating coil that is powered by AC supply and is heated up. The blower unit (331) circulates the air through specified path (333) to provide convection heat in between the bottom heating assembly (310) and top heating assembly (320), where the flatbread is placed for cooking. Specified Path (333) consists of a radiation heating system to improve cooking quality. The top heating assembly (320), the bottom heating assembly (310) and the specified path (333) act as an enclosure to hold the heat for cooking the flatbread.

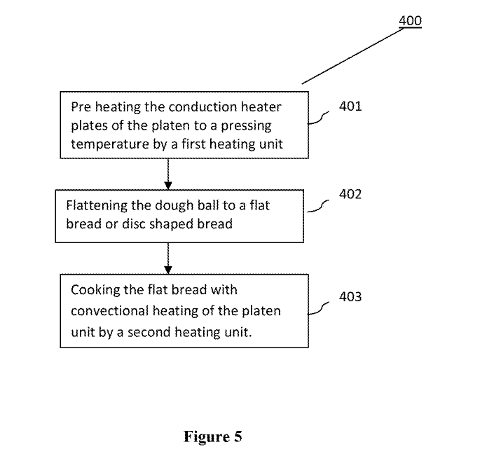

FIG. 5 illustrates the various steps involved in the method (400) for cooking dough products using conduction convectional and radiation methods of heating. The initial conductive pre-heating of the platen unit is done by the heating assemblies (310, 320). In an embodiment, the method in step 401, includes flattening a dough ball into a flatbread or a disc-shaped bread using said platen unit. The dough ball is kept on the stationary bottom heating assembly and the top heating assembly is moved upward and downward i.e. linearly to obtain a flatbread. In step 402, power is supplied to the first heating unit to provide conduction heating to the plates of the platen unit through the primary coils. The required conductive heat for cooking the flat bread is maintained in the top and bottom plates using the primary coils. In step 403, power is supplied to the second heating unit to provide convectional heating to the platen unit. The convection and conduction heat may be provided at the same time to the platen unit or after a gap of some time to cook the flatbread and make it puffy. The top plate is linearly moved through a linear motion mechanism to make the flatbread soft and puffy while conduction and convection heat is provided to the platen unit by the first and second heating unit.

Various modifications to these embodiments are apparent to those skilled in the art from the description and drawings herein. The principles associated with the various embodiment defined herein may be applied to other embodiments. Therefore, the description is not intended to be limited to the embodiments shown along with the accompanying drawings but is to be provided broadest scope consistent with the principles and novel and inventive features describe/disclosed or suggested herein. Any modifications, equivalent substitutions, improvements etc. within the spirit and principle of the present invention shall all be included in the scope of protection of the present invention.

1. A platen apparatus (300) for cooking dough products comprising:
a platen unit including a top heating assembly (320) and a bottom heating assembly (310) to press a dough ball into a flat disc,
the bottom heating assembly (310) including a first heating unit comprising at least one primary coil (311) configured to provide conductive heat to said platen unit;
a linear motion mechanism (350) configured to move said top heating assembly (320) linearly with respect to said bottom heating assembly (310); and
a second heating unit (314) including a secondary heating coil (332) and a blower unit (331) configured to provide convective heat to said platen unit; and
a control unit configured to control the heating of said platen unit;
wherein heat from said secondary heating coil (332) of said second heating unit (314) is circulated by said blower unit (331) within said platen unit; and
wherein the temperature of said second heating unit (314) is higher than the temperature of said first heating unit.

2. The platen apparatus (300) as claimed in claim 1, wherein said first heating unit and said second heating unit (314) are connected to a power supply for heating said platen unit.

3. The platen apparatus as claimed in claim 1, wherein said linear motion mechanism (350) is mounted on said top heating assembly (320).

4. The platen apparatus as claimed in claim 1, wherein said linear motion mechanism includes a plurality of shafts (342), a lead screw (341) connected to said plurality of shafts (342) by a shaft holder (345), the lead screw (341) along with the plurality of shafts (342) actuating linear motion of said top heating assembly (320) through a guide system (347) which is connected to the top heating assembly (320) by an insulating plate (348).

5. The platen apparatus as claimed in claim 1, wherein the first heating unit of the bottom heating assembly (310) comprises at least one Teflon coated heater plate (313) to enable conductive heating.

6. The platen apparatus as claimed in claim 1, wherein said platen unit includes at least one temperature sensor attached to said top and bottom assemblies to detect and monitor the temperature of heater plates of said assemblies.

7. The platen apparatus (300) as claimed in claim 1, wherein said platen unit comprises at least one contact sensor to detect the position of said top heating assembly (320).

8. The platen apparatus (300) as claimed in claim 1, wherein said platen unit comprises at least one infrared sensor to detect the position of said top heating assembly (320).

9. The platen apparatus (300) as claimed in claim 1, wherein said platen unit includes a plurality of sensors to detect whether the flatbread is cooked.

10. The platen apparatus (300) as claimed in claim 7, wherein said sensors are selected from a range of rotary encoder sensors, infrared sensors, hall sensors, contact sensors and ultrasonic sensors.

11. The platen apparatus (300) as claimed in claim 1, wherein said control unit cuts off the power supplied to said platen unit, when the flatbread is cooked by said platen apparatus.

12. The platen apparatus (300) as claimed in claim 1, wherein said blower unit (331) is a fan to circulate air through a specified path (333) around the secondary heating coil (332) and the apparatus to provide convection heat in between the bottom heating assembly (310) and top heating assembly (320) in a region where the flatbread is placed for cooking, and wherein the specified path (333) comprises a radiation heating system to improve cooking quality.

13. The platen apparatus as claimed in claim 1, wherein the cooking surface of said top heating assembly (320) and said bottom heating assembly (310) is coated with a non-sticky material.

14. The platen apparatus (300) as claimed in claim 11, wherein said non-sticky material is Teflon.

15. A method (400) for cooking dough products comprising the steps of
a) flattening a dough ball into a flatbread using a platen unit comprising a top heating assembly (320) and a bottom heating assembly (310);
b) providing conduction heat to said flatbread using said bottom heating assembly (310) and top heating assembly (320), said bottom heating assembly (310) comprising a first heating unit configured to provide conductional heat to said platen unit; and
c) providing convectional heat to said flatbread using a second heating unit (314); wherein the temperature of said second heating unit (314) providing convectional heat is greater than the temperature of said first heating unit providing conductional heat to said platen unit.

16. The method (400) as claimed in claim 15, wherein the first heating unit comprises at least one Teflon coated heater plate (313) to enable conductive heating.

17. The method (400) as claimed in claim 15, wherein the conduction heat is provided by said first heating unit simultaneously with the convectional heat provided by said second heating unit (314).

18. The method (400) as claimed in claim 15 wherein said flatbread is cooked by the linear motion of said top heating assembly (320) and the combination of conduction heat provided by said first heating unit and convection heat provided by said second heating unit (314).

19. The method (400) as claimed in claim 15, wherein said linear motion of said top heating assembly (320) is caused by a linear motion mechanism (350).

20. The method (400) as claimed in claim 19, wherein said linear motion mechanism includes a plurality of shafts (342), a lead screw (341) connected to said plurality of shafts (342) by a shaft holder (345), the lead screw (341) along with the plurality of shafts (342) actuating linear motion of said top heating assembly (320) through a guide system (347) which is connected to the top heating assembly (320) by an insulating plate (348).

21. The method (400) as claimed in claim 15, wherein said first heating unit includes at least one primary coil (311) configured to provide conductive heat to said platen unit.

22. The method (400) as claimed in claim 15, wherein said second heating unit (314) includes a secondary heating coil (332) and a blower unit (331) configured to provide convective heat to said platen unit.

23. The method (400) as claimed in claim 22, wherein said blower unit (331) is a fan to circulate air through a specified path (333) around the secondary heating coil (332) and the apparatus to provide convection heat in between the bottom heating assembly (310) and top heating assembly (320) in a region where the flatbread is placed for cooking, and wherein the specified path (333) comprises a radiation heating system to improve cooking quality.

24. The method (400) as claimed in claim 15, wherein said platen unit includes at least one temperature sensor attached to said top and bottom assemblies to detect and monitor the temperature of heater plates of said assemblies.

25. The method (400) as claimed in claim 15, wherein said platen unit comprises at least one contact sensor to detect the position of said top heating assembly (320).

26. The method (400) as claimed in claim 15, wherein said platen unit comprises at least one infrared sensor to detect the position of said top heating assembly (320).

27. The method (400) as claimed in claim 24, wherein said sensors are selected from a range of rotary encoder sensors, infrared sensors, contact sensors, hall sensors and ultrasonic sensors.

28. The method (400) as claimed in claim 15, wherein said platen unit includes a plurality of sensors to detect whether the flatbread is cooked.

29. The method (400) as claimed in claim 15, wherein the amount of heat supplied by said first heating unit and said second hearting unit (314) is controlled by a control unit.

30. The platen apparatus (300) as claimed in claim 12, wherein the top heating assembly (320), the bottom heating assembly (310) and the specified path (333) act as an enclosure to hold the heat for cooking the flatbread.
